(19) United States
(12) Patent Application Publication
(10) Pub. No.: US 2019/0077561 A1
(43) Pub. Date: Mar. 14, 2019

(54) GLOW IN THE DARK CONTAINERS

(71) Applicants: Todd Jackson Jett, Yoakum, TX (US); Kristopher Paige Gostecnik, Victoria, TX (US)

(72) Inventors: Todd Jackson Jett, Yoakum, TX (US); Kristopher Paige Gostecnik, Victoria, TX (US)

(21) Appl. No.: 16/127,916

(22) Filed: Sep. 11, 2018

Related U.S. Application Data
(60) Provisional application No. 62/557,325, filed on Sep. 12, 2017.

(51) Int. Cl. B65D 65/38; B65D 81/38; B65F 1/02; B65D 25/54; B65F 1/16; C09K 11/02; C09K 11/64

(52) U.S. Cl. CPC B65D 65/38; B65D 81/3813; B65F 1/02; B65D 25/54; B65F 2220/128; C09K 11/02; C09K 11/643; B65F 2210/139; B65F 1/16

(57) ABSTRACT

A container includes a housing which includes a ‘glow in the dark’ material on an exterior surface of the housing and ‘glow in the dark’ material on an interior surface thereof.

### CROSS-REFERENCE TO RELATED APPLICATIONS

This application claims benefit of U.S. Provisional Patent Application Ser. No. 62/557,325, filed Sep. 12, 2017, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Containers appear everywhere in society. They are used all hours of the day, in daytime and nighttime activities. However, in darkness, containers can be difficult and/or unsafe to use.

A number of products and applications incorporate “glow in the dark” materials. Glow in the dark objects can make nighttime activities safer and easier by providing lighting. Examples of glow in the dark products include balls, signs, paint, tape, novelty items, etc.

‘Glow in the dark’ materials may, for example, include phosphorescents. There are many different phosphorescent materials that, after charging, emit light for various time spans (some up to 24 hours) and in various colors, including yellow, orange, green, pink, red and blue. Common phosphorescent materials include, for example, activated zinc sulfides and strontium aluminates. See, for example, U.S. Pat. No. 5,424,006 and U.S. Pat. No. 6,207,077, the disclosures of which are incorporated herein by reference. Strontium aluminate phosphorescents are especially useful because their phosphorescence is both bright and long lasting. Phosphorescent materials have been added to products as coatings, mixtures, applied via straps, melt blended, etc.

### SUMMARY

In one aspect, a container includes a housing which includes a ‘glow in the dark’ material on an exterior surface of the housing and ‘glow in the dark’ material on an interior surface thereof (that is, on a surface of an enclosed, interior volume thereof). The housing may, for example, include an openable lid to provide access to an inner volume of the container, the interior surface defining at least a portion of the inner volume.

In a number of embodiments, the container may further include at least one translucent section in the housing. The at least one translucent section may, for example, be adapted to pass light into an interior of the housing to activate the ‘glow in the dark’ material on the interior surface.

In a number of embodiments, each of the at least one interior surface and the at least one exterior surface of the container includes at least one polymeric material containing 2-12 wt % of a phosphor material. The phosphor material may, for example, be selected from the group consisting of zinc sulfide, rare earth metal aluminates, and rare earth metal alumino-silicates doped with activators. In a number of embodiments, the phosphor material comprises activated SrAl₂O₃.

The translucent section may, for example, include a translucent polymeric material. In a number of embodiment, the translucent polymeric material contains 0.1-10 wt % of a phosphorescent material.

In a number of embodiments, the container includes a movable ‘glow in the dark’ element attached to the housing. In a number of embodiments, the container includes a tethered ‘glow in the dark’ rope attached thereto.

The container may, for example, further include at least one member on the housing to provide a dimensional reference for range finding.

In a number of embodiments, the container is selected from the group consisting of a thermally insulated cooler and a trash can/receptacle.

In another aspect, a container includes a housing which includes ‘glow in the dark’ material on an exterior surface of the housing and a movable section attached to the housing, The movable element includes a ‘glow in the dark’ material on a surface thereof. The movable element may, for example, be tethered to the housing. The movable element may, for example include or form a portion of the housing.

In a further aspect, a container includes a housing which includes ‘glow in the dark’ material on an exterior surface of the housing and at least one member on the housing to provide a dimensional reference for range finding.

In still a further aspect, a thermally insulated container or a trash/refuse container includes a housing which includes a ‘glow in the dark’ material on an exterior surface of the housing. The container may, for example, further include ‘glow in the dark’ material on an interior surface thereof (that is, on a surface of an enclosed, interior volume thereof). The housing may, for example, include an openable lid to provide access to an inner volume of the container. The interior surface defines at least a portion of the inner volume.

The present ‘glow in the dark’ containers and fabrication methods along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates an embodiment of a thermally insulated container or cooler hereof with optional window or translucent section, in which the cooler is in an open state.

FIG. 2 illustrates the cooler of FIG. 1A in a closed state.

FIG. 3 illustrates another embodiment of a cooler hereof including a movable ‘glow in the dark’ portion, which may be used as a mobile light source.

FIG. 4 illustrates the cooler of FIG. 3 wherein a movable ‘glow in the dark’ portion is detached and also including a dimensional reference for range finding.

FIG. 5 illustrates an embodiment of a refuse or trash can or receptacle hereof with an optional translucent lid, one or more optional translucent windows, and/or one or more optional side portions.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a phosphorescent material” includes a plurality of such phosphorescent materials and equivalents thereof known to those skilled in the art, and so forth, and reference to “the phosphorescent materials” is a reference to one or more such phosphorescent materials and equivalents thereof known to those skilled in the art, and so forth. Recitation of ranges of values herein are merely intended to serve as a shorthand method of referring individually to each separate value falling within the range. Unless otherwise indicated herein, and each separate value, as well as intermediate ranges, are incorporated into the specification as if individually recited herein. All methods described herein can be performed in any suitable order unless otherwise indicated herein or otherwise clearly contraindicated by the text.

It has long been desired to make containers easier and safer to use, especially in dark environments. One way to make containers easier and safer to use is to make the container more visible by incorporating one or more “glow in the dark” functionalities. In a number of embodiments hereof, novel multi-functional containers, container systems and methods associated therewith incorporate ‘glow in the dark’ functionalities, properties and/or features. Representative examples of such containers include coolers and trash cans/receptacles. Containers refer to objects that are used to store, hold, and/or transport items. As used herein, the term “container” refers to an device or object that can be used to hold or transfer one or more items (for example, boxes, cans, chests, cases, etc.). In a number of embodiments, chambers hereof include a housing which includes an openable/closable housing member, lid or cover. In a number of embodiments, containers hereof are waterproof and/or leak proof to gasses, liquids, and solids. Containers hereof may also be buoyant (that is, able to stay afloat in, for example, water).

‘Glow in the dark’ objects give off light after absorbing energy. Thus, as used herein, the term ‘glow in the dark’ refers to emission of light after removal of incident energy. The energy source can be biological, chemical, electromagnetic, etc. Luminescence refers to objects that give off light, but not as a result of being heated. Photoluminescence refers to materials that emit light after absorbing electromagnetic energy. Examples of photoluminescence include fluorescence and phosphorescence.

Unlike fluorescents, phosphorescents do not immediately re-emit the absorbed energy as light, but emit the absorbed energy over time. Phosphorescent materials are also called phosphors. The duration and intensity of a phosphor's afterglow depends on several variables including its composition, particle size, excitation light source and intensity, concentration, film thickness, environment, etc. Phosphors used for ‘glow in the dark’ applications generally are activated using ultra-violet and/or visible light. They can be activated using daylight, flashlights, black lights, fluorescent light, lasers, etc.

Some phosphorescents can emit light up to about 24 hours after absorbing electromagnetic energy. For this reason, phosphorescents have become popular and useful ‘glow in the dark’ materials. Two common phosphorescent materials comprise zinc sulfide and strontium aluminate doped with activators.

The choice of activator (as well as other physical properties) often changes the color of the emitted light. For example, when silver is used as activator for zinc sulfide, the resulting phosphorescence is bright blue, with a maximum wavelength at approximately 450 nanometers. When manganese is used as an activator, ZnS:Mn emits an orange-red color at around 590 nanometers. ZnS:Cu gives a longer-time glow, and emits a green color at about 507 nm. Other sulfide phosphorescents include CaS:Bi (violet blue phosphorescence), CaStS:Bi (a blue phosphorescence), and ZnCdS:Cu (yellow orange phosphorescence).

An extensively used sulfide phosphorescent is zinc sulfide activated with copper (ZnS:Cu). However, many of the sulfide phosphorescents are chemically unstable and their phosphorescence degrades over time. For example, zinc sulfide can blacken and decompose in presence of ultraviolet radiation and moisture. Thus, zinc sulfide phosphors, may have a shortened lifetime when used outdoors.

Another class of phosphors include alkaline earth metal aluminates and alkaline earth metal alumino-silicates. When doped with small amounts of europium, dysprosium, boron, and the like, these phosphors have been shown to emit light up to about 24 hours after their activation with light energy. In addition, these phosphors are chemically stable and resistant to oxidation.

Strontium aluminate doped with europium is one of the most commonly used ‘glow in the dark’ materials. Compared with ZnS:Cu, strontium aluminate based phosphorescents glow much brighter and much longer after activation with light. See, for example, “Optical Properties of Rare Earth Doped Strontium Aluminate (SAO) Phosphors: A Review, Optics and Spectroscopy, November 2014, the disclosure of which is incorporated herein by reference.

Strontium aluminate based phosphorescents emit light in many colors, including violet, pink, white, orange, red, green, and blue, depending on the activator(s) used, preparation conditions, etc. They are activated by electromagnetic radiation in the wavelength range from about 200-450 nm, with best results obtained using ultra violet wavelengths between about 200 and 350 nm. The commonly used SrAl₂O₄:Eu²⁺ powder emits a green light at circa 530 nanometers.

Both the ZnS and SrAl₂O₃ type phosphorescents, as well as other phosphorescents, are available commercially as powders, which may, for example, be incorporated into polymer master batches, mixed into paints, applied to tapes, etc.

In a number of embodiments hereof, one or more ‘glow in the dark’ materials, such as those described above, are incorporated into containers. Coating, attaching or incorporating ‘glow in the dark’ material(s) on or within all or a desired portion of a container imparts a photo-luminescent or ‘glow in the dark’ character to the container. The ‘glow in the dark’ material can be applied via ‘glow in the dark’ paint, affixing a ‘glow in the dark’ tape, attaching ‘glow in the dark’ objects via straps and/or fasteners, etc.

In a number of embodiments, containers hereof include or are formed from polymers such as thermoplastic materials. One or more ‘glow in the dark’ materials may, for example, be incorporated into the thermoplastic materials via conventional melt mixing techniques, such as molding, extrusion, calendaring, melt spinning, etc. Thermoplastic polymers which may be used in containers hereof include, for example, polyolefins, acrylics, acrylonitrile butadiene styrene (ABS), polymethylmethacrylate, polyethylene terephthalate, nylon, polycarbonate, polyvinylchloride, polystyrene, etc.

In other embodiments, containers hereof include or are formed from thermoset and/or cross-linked polymeric materials (for example, acrylic resins, polyesters, epoxies, polyurethanes, cross-linked rubbers, etc.). ‘Glow in the dark’ material(s) may, for example, be added to a monomer or prepolymer mixture before polymerization and/or curing.

The phosphorescent materials may, for example, be mixed homogeneously through the container's polymer matrix, applied preferentially to a certain area or areas of the container, added to one or more specific layers of the container, applied preferentially to the inside surface(s), exterior surface(s) of the container, etc. In a number of embodiments hereof, containers hereof include one or more phosphorescent materials on at least one outside surface thereof and on at least one inside or inner surface thereof.

In a number of embodiments, two or more different color phosphors or phosphorescent materials are incorporated into a container hereof. The different color phosphors can be mixed together or incorporated separately. The container may include a plurality of sections, each incorporating a single phosphor or a plurality of phosphors.

For opaque, colored, filled, and/or non-transparent polymers, the amount of visible ‘after glow’ increases when the ‘glow in the dark’ material is concentrated on or near the surface of the container. For translucent polymers, an amount of phosphor can be added such that the polymer's translucent property is retained.

For containers including or formed from polymeric materials, from about 1 to 30 percent of a photo-luminescent compound may, for example, be mixed into about 70 to 99 percent of the polymer. In a number of embodiments, about 2 to 12 percent of a photo-luminescent compound may be mixed into about 90 to 98 percent of the polymer. The afterglows of these polymer/phosphor matrices are stable and have long afterglow times after exposure to ultraviolet or visible light (that is, light in the ultraviolet or visible spectrum). For Sr(Al₂O₃) type phosphorescent materials, a few minutes exposure to UV or visible light can create an after-glow duration up to about 24 hours.

Containers hereof may, for example, include separate compartments, or contain hidden ‘secret’ compartments. Containers hereof may, for example, include removable and/or fixed partitions to configure and define an interior space or compartments of the container. One or more secret compartments may, for example, be used to hold tracking devices, store hunting/fishing scents, etc.

In a number of embodiments, containers hereof are portable. Portable containers hereof may, for example, include removable or non-removable/permanent wheels. Containers hereof may, for example, be insulated and/or water proof. Thermally insulated containers may, for example, be formed with closed cell foam, open cell foam, or any intermediate material that has an r-factor between 0.5 and 9.0 per inch thickness.

As described above, ‘glow in the dark’ functionalities or properties allow the containers to be readily used in darkness. A ‘glow in the dark’ container may, for example, be used, as a storage device to store food, liquids, ice, clothing, medical supplies, test equipment, communication equipment, emergency/survival supplies, welding supplies, compressed air, refuse, etc. Some envisioned embodiments include ‘glow in the dark’ insulated ice coolers, trash cans/receptacles, ice buckets, emergency containers, soft-sided coolers, etc.

‘Glow in the dark’ containers hereof may be used where no electricity is available or desired. For example, ‘glow in the dark’ containers may be used during nighttime fishing, hunting, and camping activities. In a number of embodiments, the container's afterglow is not offensive or frightening to animals and can be used to mark feeders, game cameras, etc. ‘Glow in the dark’ containers may also be used in mines and for spelunking. In addition, they can be used for nighttime garbage pickup including mechanical garbage pickup. In boating and diving activities, floating ‘glow in the dark’ containers may be used to mark dive areas and to store supplies, food, medicine, clothing, etc.

‘Glow in the dark’ containers hereof enhance nighttime safety. ‘Glow in the dark’ containers hereof may, for example, be seen for miles in line of sight applications. A hunter carrying a ‘glow in the dark’ container hereof is better protected against accidental shooting. ‘Glow in the dark’ trash receptacles or cans hereof are less like to be hit by cars or other vehicles. Floating ‘glow in the dark’ containers can aid nighttime diver rescue, pickup, delivery of supplies, etc. Further, by marking nighttime diving activities with a floating ‘glow in the dark’ container, danger from collision with boats is minimized. ‘Glow in the dark’ containers can additionally light walkways, mark dangerous boundaries, meeting locations, waypoints, emergency runways and landing areas.

In a number of embodiments, ‘glow in the dark’ containers hereof allow communication via “light painting”. For example, a narrow-beam light emitting device (for example, a laser pointer, light emitting diode, or the like) can be used to inscribe messages, patterns, etc. on a ‘glow in the dark’ container. Writing with light onto a ‘glow in the dark’ container produces a similar, but glowing image/message emitted from the ‘glow in the dark’ container. After creating the message, pattern, etc., the glowing image can easily be discharged (i.e., erased) by blanketing the image with an emerald (green) light.

‘Glow in the dark’ containers hereof may additionally enable fast identification of meeting points, etc. at crowded nighttime/dark venues, for example, at sporting events and/or tailgating parties.

Containers hereof may be of any size and have one or more inner compartments of any size. In a number of embodiments, a ‘glow in the dark’ container hereof holds (or has an interior volume of) a minimum of 4 quarts and a maximum of 1,300 quarts. The shape of containers hereof may be of any convenient geometry (example, include, but are not limited to cubical, rectangular, cylindrical, conical, etc.). A ‘glow in the dark’ container hereof may have single wall construction or multi-wall construction, and may include void spaces or insulation between walls. The void spaces may contain a gas or be evacuated to vacuum. Each wall may include a plurality of layers.

In a number of embodiments, ‘glow in the dark’ containers further include one or more translucent sections in the housing thereof (for example, windows, lids, panels, etc.). Translucent sections enable viewing into the container without having to open it. Translucent windows further allow the inside surfaces of a ‘glow in the dark’ container (which also include “glow in the dark” materials) to charge during the daytime and then glow in darkness, thus providing for illuminating the inside of the container in darkness.

Translucent windows, lids, and/or other sections, in the housings of containers hereof be of any convenient size and shape (for example, rectangular, square, circular, oval, etc.). In a number of embodiments, one or more translucent sections may be incorporated into one or more sides or surfaces of a container (for example, in the lid, a side, a corner, the bottom, etc.). In other embodiments, the entire lid, side, or section of a glow in the dark container hereof may be translucent. A translucent section or portion of a container hereof may be made of any convenient material known to those skilled in the art, including translucent polymers, glass, and the like. The translucent section may, for example, be semitransparent or transparent.

In a number of embodiments, translucent sections hereof are formed from translucent polymers. Examples of translucent polymeric materials include polyurethane, polystyrene, polyvinylchloride, polycarbonate, acrylonitrile butadiene styrene (ABS), polymethylmethacrylate, polyethylene terephthalate, co- and ter-polymers of ethylene, propylene, butene, hexene, octene, etc.

Translucent sections of containers hereof may, for example, be fabricated using known methods known to those skilled in the art. Translucent sections may be single pane, formed with a plurality of panes, molded, include a structural sandwich, include a honeycomb, a foam, etc. Translucent sections may be insulated, include spaces under vacuum, or filled with air, argon, krypton, or other gasses.

A translucent section or window may be incorporated into a ‘glow in the dark container via conventional methods known to those skilled in the art. In a number of embodiments, they can be glued, fused, welded, attached via fasteners, attached via a frame, etc. In a number of embodiments, translucent sections or windows are air and water-proof

In a number of embodiments, a translucent section hereof is removable. For example, a removable translucent section or window may be fabricated such that it snaps, clamps, screws, or attaches into place. In some embodiments, a removable translucent section fits into an attached frame on a container hereof. In other embodiments, a removable translucent section can be attached via friction forces, attached using compression/expansion fittings, seals, etc. A circular translucent section may be threaded and designed to screw into/onto a female or male threaded opening on the container. Such threaded connection may, for example, facilitate a sealed connection. In other embodiments, a translucent section may be opened, for example by a hinge or sliding mechanism.

In a number of embodiments, a translucent section hereof also includes ‘glow in the dark’ material(s). For translucent polymeric sections, an amount of phosphor can be added such that the polymer's translucent property is retained. A translucent ‘glow in the dark’ section provides both a window into the interior of the container and additionally provides nighttime lighting into and surrounding the container.

As use herein, the term “multi-functional” refers to devices, systems and/or methods having several functions or purposes. A multi-functional container may, therefore, refer to a container with functions and/or purposes other than holding or transporting items.

In a number of embodiments, a multi-functional ‘glow in the dark’ container includes a plurality of ‘glow in the dark’ functions. This additional functionality is enabled either by the container's ‘glow in the dark’ properties, or by a distinct and separate ‘glow in the dark’ functionality. A ‘glow in the dark’ container may, for example, include a moveable or removable ‘glow in the dark’ portion, component or element. The moveable or removable ‘glow in the dark’ portion, component or element can be used as a source of illumination to illuminate the inside compartment(s) of the ‘glow in the dark’ container, or to illuminate other dark areas. The moveable or removable ‘glow in the dark’ portion, component or element may, for example, be attached to or tethered to the container via a snap fit connection, a cooperating docking connection, wire, string, rope, cord, etc.

In some embodiments, a floating ‘glow in the dark’ storage container may further include a separate ‘glow in the dark’ tethered line that enables divers to locate the glowing line under water and lead them to the storage container/pickup point. The tethered line may, for example, be detachable.

In further embodiments, a ‘glow in the dark’ placard of known size is affixed to a ‘glow in the dark’ cooler, container, or trash receptacle. The placard can define a ruler, evenly spaced concentric rings, or other objects of known size that enable fast nighttime range-finding using conventional aiming optics or stadiametric rangefinding (for example, using mil-dot reticles). The placard may, for example, include ‘glow in the dark’ material or non-‘glow in the dark’ material, and may, for example, have a different color or glow property than the remainder of the container. When the cooler, container, or trash receptacle is placed at game feeders, game cameras, or other locations, the affixed placard enables fast distance calculation using conventional aiming optics, thus improving nighttime hunting without additional lighting. In addition, the afterglow may not be offensive or frightening to animals.

In a number of embodiments, one or more items, features or markings of knows dimensions such rulers, evenly spaced concentric rings, or designs of known dimension or spacing are incorporated into or attached to the exterior surface of a ‘glow in the dark’ cooler, trash receptacle or other container hereof. When the container hereof is positioned at, for example, game feeders, game cameras, or other locations, the incorporated item of know dimension enables fast range finding and distance calculation using conventional aiming optics (for example, mil dot systems), thereby improving nighttime hunting or other activated in which distance must be measure in low light without additional lighting.

As described above, ‘glow in the dark’ functionalities for ‘glow in the dark’ containers hereof may include moveable or removable ‘glow in the dark’ sections, ‘glow in the dark’ signs, clocks, dials, compasses, range finders, secret compartments, safety placards, straps, hooks, fasteners, openers, color charts, indicator markings, keypads, etc.

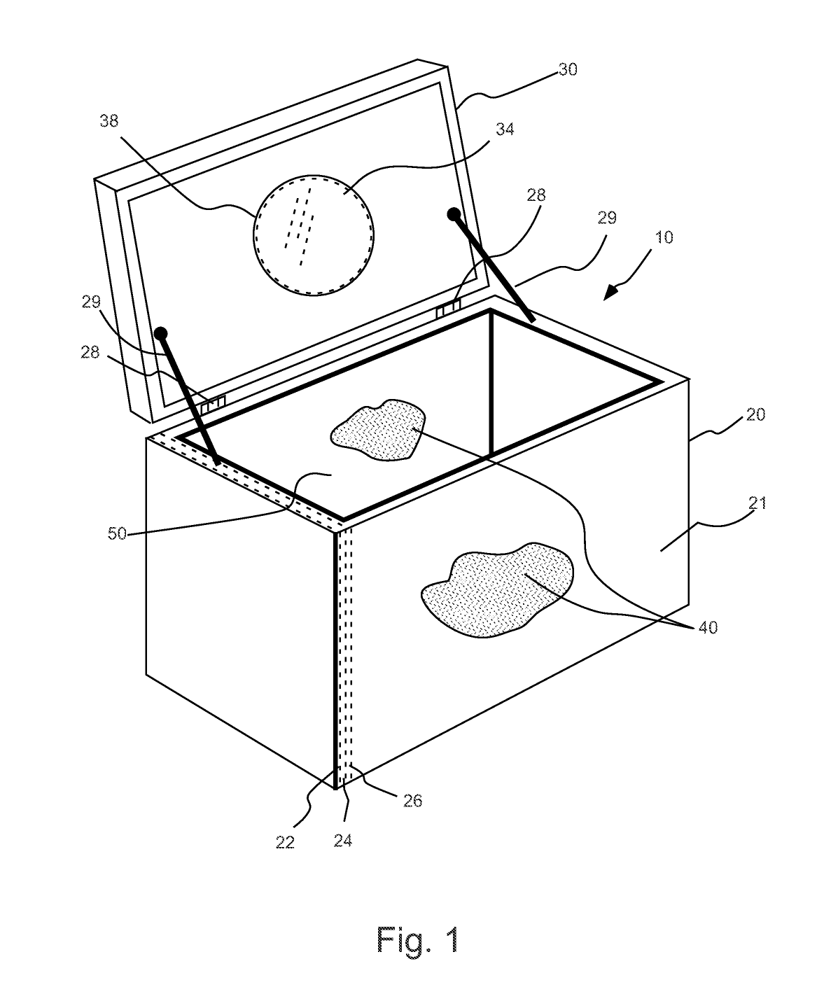

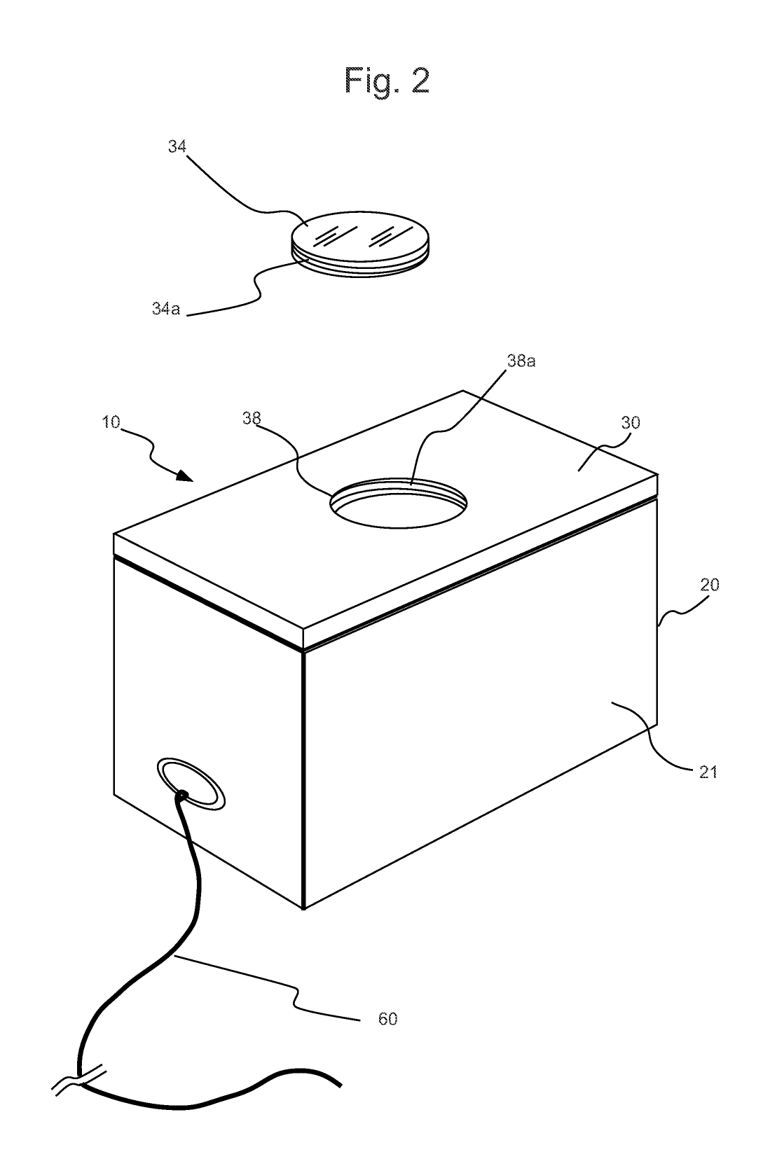

FIGS. 1 and 2 show a representative and illustrative embodiment of an insulated ‘glow in the dark’ cooler 10 hereof. Cooler 10 is generally rectangular or cuboidal in shape, but can be made to any convenient shape/dimensions. A body or housing 20 of the cooler may, for example, include a plurality of insulated walls that define an interior chamber of volume 50. Housing 20 may, for example, include an outer liner 22 and an inner liner 26 as illustrated schematically for one side panel in FIG. 1. An insulating material 24 may, for example, positioned between inner liner 22 and outer liner 26. Housing 20 of cooler 10 further include a main body section 21 and a top section or lid 30 attached to body section 21. Lid 30 may also include an outer liner, an insulating material, and an inner liner (not shown) as described for a side panel of main body 21 above. Lid 30 may, for example, be attached to body 21 by a plurality of hinges 28, wherein lid 30 is movable between a closed state (see FIG. 2) to an open state (see FIG. 1). As illustrated in FIG. 1, supports 29 (for example, lengths of flexible wire or rigid extending members) may, for example, be provided to maintain lid 30 in a desired position while in an open state. Cooler 10 may optionally include a translucent window or section that may or may not include ‘glow in the dark’ material. As known in the cooler arts, cooler 10 may optionally include a latching mechanism for lid 30, one or more handles, a drain plug, a pressure relief valve, (which may be either removable or fixed) etc.

A plurality of the cooler components comprise polymeric materials as described above. The polymeric materials may comprise thermoplastics, thermosets, cross-linked polymers, translucent polymers, open-cell or closed-cell foam insulation, etc. Additionally, a plurality of the polymeric components may comprise ‘glow in the dark’ materials. In a number of embodiments, about 5 weight % of a commercially obtained SrAl₂O₃:Eu phosphor was homogeneously blended in the liners of the lid and body during the molding process. The cooler may, for example, emit a green light at having a wavelength of approximately 530 nanometers after activation with UV and/or visible light.

Container hereof, such as cooler 10 may, for example, include ‘glow in the dark’ materials both on the outer surface of housing 10 and on the inner surface of housing 20 (as, for example, represented schematically by areas of ‘glow in the dark material’ 40 in FIG. 1). A portion of the entirety of the inner and/or outer surface of housing 20 may include ‘glow in the dark’ materials. Such ‘glow in the dark’ materials may be charged upon exposure to a light source such as the sun or electrical lighting. Charging of the interior wall or surface of inner volume 50 may, for example, occur by leaving lid 30 in an open state in a lit area. Further or alternatively, charging of the inner wall or surface of inner volume 50 may occur via translucent section or window 34. Translucent section 34 may, for example, provide functions of allowing a user to look into inner volume 50 without opening lid 30 and to allow light into inner volume 50 without opening lid 30 to charge ‘glow in the dark’ materials in/on the inner surface of inner volume 50. Providing ‘glow in the dark’ materials 40 in/on the inner wall of inner volume 50 (including the side walls, lower wall, and or the lower wall of lid 30) provides lighting to a user of inner volume 50 when lid 30 is opened in a darkened area.

Translucent section or window 34 is illustrated in lid 30 in the illustrated embodiment, but one or more such translucent sections may be placed in main body 21 as well. As described above, translucent section 34 may be removable. As illustrated in FIG. 2, a circular translucent section 34 may be removably connected to a port or seating 38 formed in lid 30 (or elsewhere in cooler 10) via cooperation of threading 34a of translucent section 34 with cooperating threading 38a of port 38. Handles or gripping areas (not shown) may be provided on translucent section 34 to provide ease of removal/connection.

As described above, cooler 10 may further include a ‘glow in the dark’ tethered line 60 (see FIG. 2) that, for example, enables divers to locate glowing line 60 under water and lead them to floatable/buoyant storage container 60 which may designate pickup point. Tethered line 60 may, for example, be detachable.

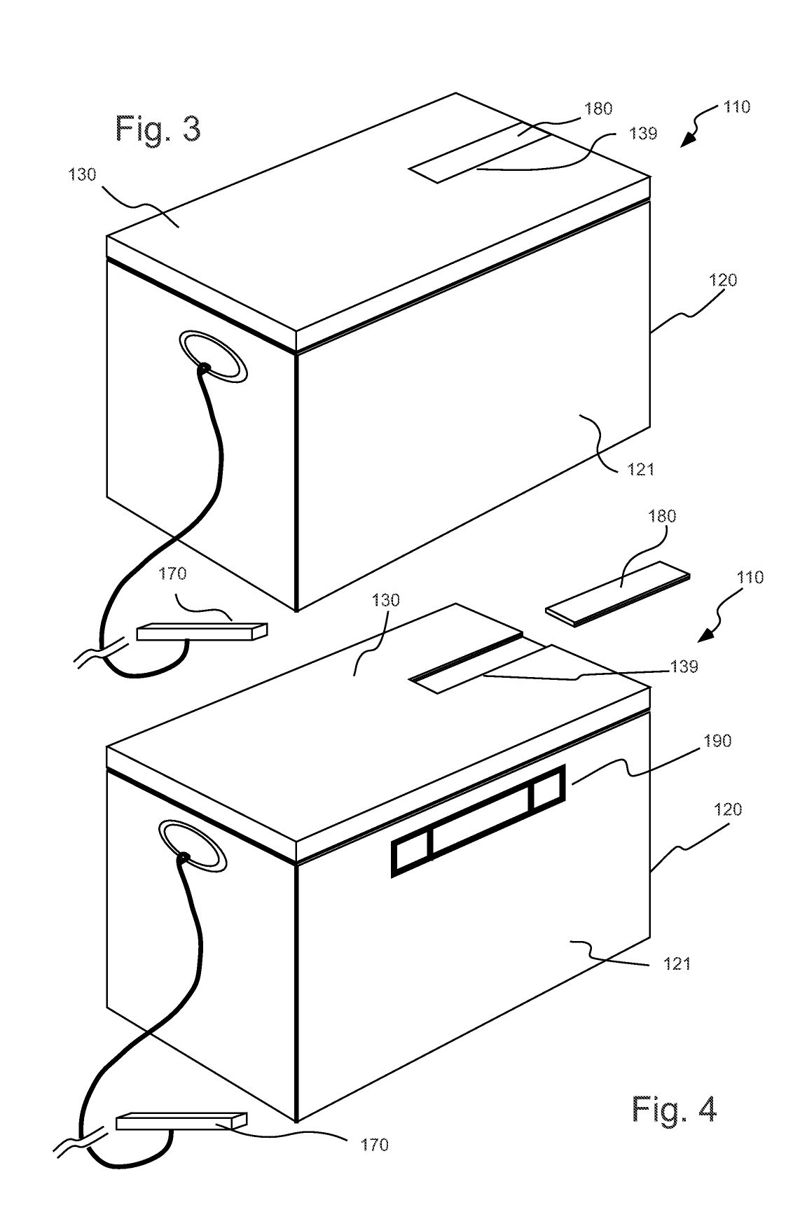

As illustrated in FIGS. 3 and 4, in a number of embodiments, a ‘glow in the dark’ cooler 110 or other container hereof may include a moveable (relative to cooler 110) or removable ‘glow in the dark’ portion or element. As illustrated in, for example, FIG. 3 ‘glow in the dark’ element 170 may be movably tethered to cooler 110 and ‘glow in the dark’ element 180 may be removably attached to housing 120 via a seating 139 (for example, via a cooperating tongue/groove system or a snap fit system). Element 180 is shown removed from connection with cooler 110 in FIG. 4. Moveable ‘glow in the dark’ portion or element 170 may, for example, be tethered to cooler 110 using a string, rope, cord, etc. ‘Glow in the dark’ element 170 and/or element 180 may, for example, be used as a source of illumination to light the inside compartment of ‘glow in the dark’ cooler 110 and/or to illuminate other darkened areas.

‘Glow in the dark’ cooler 110 or other containers hereof may further include a range finding device or system as described above. The range finding device or system may, for example, include a ‘glow in the dark’ item or ruler 190 (see FIG. 4) of known dimension or ‘glow in the dark’ spaced concentric rings of known spacing and/or dimension. The range finding device may be affixed to cooler 110 as a placard, or integrally molded into cooler 110. Like elements of cooler 110 are numbered or designated similarly to corresponding elements of cooler 10 with the addition of 100 to the number or designation.

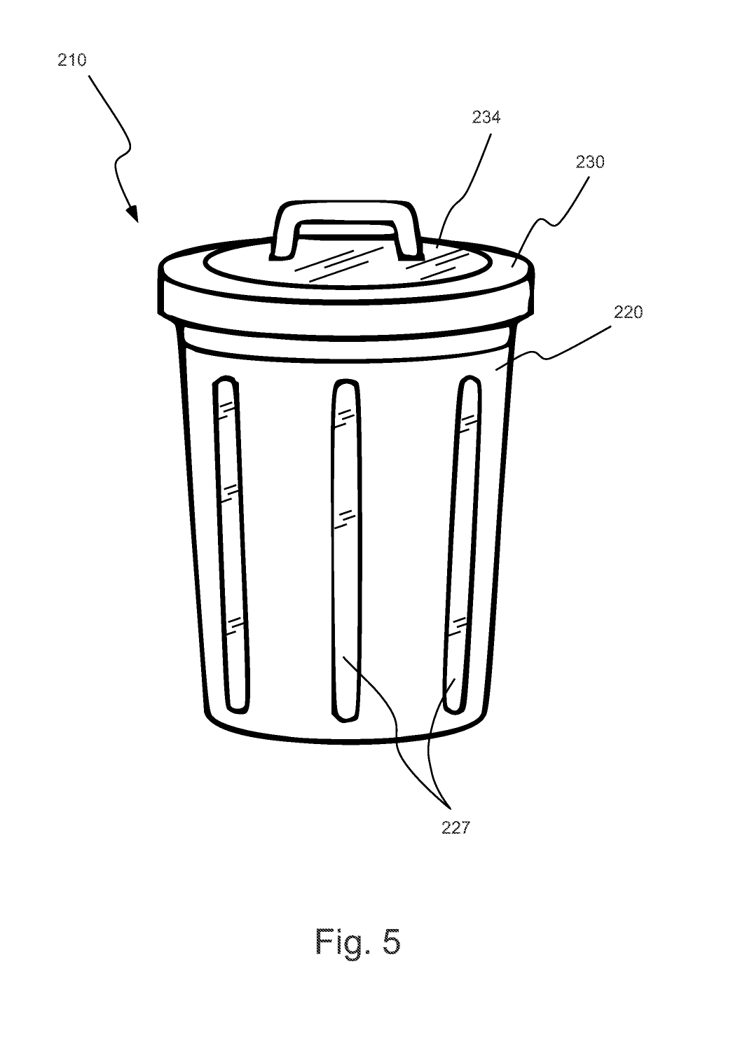

FIG. 5 illustrates a representative embodiment of a ‘glow in the dark’ refuse or trash can or receptacle 210 with an optional translucent sections or windows 227 in a lower section 220 thereof and an optional translucent section or window 234 in a lid 230 thereof. The trash can illustrated may for example be of polymeric construction. Lower section 220 is illustrated as frustoconical in shape, but can also be rectangular, square, or other convenient shape. Translucent sections or windows 227 and/or 234 may be of any convenient size and shape, and may optionally include ‘glow in the dark’ material. The translucent sections or windows 227 and/or 234 allow viewing of the trash can's interior without lifting lid 230, minimizing exposure to odors, insects, and bacteria. Translucent sections windows 227 and/or 234 further allow ‘glow in the dark’ inside surfaces of the trash to be charged or activated during the daytime. In other embodiments, a ‘glow in the dark’ trash can may, for example, include four sides sections, a bottom section and a lid. A plurality of translucent sections or windows may be incorporated into the corners, sides, or lid of such a cuboidal trash can.

A number of novel ‘glow in the dark’ containers are described herein. Such containers may include ‘glow in the dark’ functionality both on the exterior and on the interior of the container. Inclusion of translucent sections or windows enables interior volume(s) of the container to be activated or charged, for example, by daylight. A number of additional functionalities may also be added to ‘glow in the dark’ containers hereof. For example, ‘glow in the dark’ containers hereof may additionally include moveable/removable ‘glow in the dark’ elements, placards, range finders, sighting tools, secret compartments, clocks, dials, compasses, signs, straps, hooks, fasteners, openers, color charts, indicator markings, keypads, etc. that enable nighttime activities.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A container comprising a housing, the housing including ‘glow in the dark’ material on an exterior surface of the housing and ‘glow in the dark’ material on an interior surface thereof.

2. The container of claim 1 wherein the housing comprises an openable lid to gain access to an inner volume of the container, the interior surface defining at least a portion of the inner volume.

3. The container of claim 2 further comprising at least one translucent section in the housing.

4. The container of claim 3 wherein the at least one translucent section is adapted to pass light into an interior of the housing to activate the ‘glow in the dark’ material on the interior surface.

5. The container of claim 2 wherein each of the at least one interior surface and the at least one exterior surface of the container comprises at least one polymeric material containing 2-12 wt % of a phosphor material.

6. The container of claim 5 wherein the phosphor material is selected from the group consisting of zinc sulfide, rare earth metal aluminates, and rare earth metal alumino-silicates doped with activators.

7. The container of claim 6 wherein the phosphor material comprises activated SrAl₂O₃.

8. The container of claim 3 wherein the at least one translucent section comprises a translucent polymeric material.

9. The container of claim 8 wherein the translucent polymeric material contains 0.1-10 wt % of a phosphorescent material.

10. The container of claim 2 further comprising a movable ‘glow in the dark’ element attached to the housing.

11. The container of claim 2 further comprising a tethered ‘glow in the dark’ rope attached thereto.

12. The container of claim 2 including at least one member on the housing to provide a dimensional reference for range finding.

13. The container of claim 2 wherein the container is a thermally insulated cooler or a trash receptacle.

14. A container comprising a housing, the housing including ‘glow in the dark’ material on an exterior surface of the housing and a movable element attached to the housing, the movable element including a ‘glow in the dark’ material on a surface thereof.

15. The container of claim 14 wherein the movable element is tethered to the housing.

16. The container of claim 14 wherein the movable element forms a portion of the housing.

17. The container of claim 14 wherein the container is a thermally insulated cooler or a trash receptacle.

18. The container of claim 17 wherein the housing further comprises ‘glow in the dark’ material on an interior surface thereof.

19. The container of claim 18 wherein the housing further comprises at least one translucent section adapted to pass light into an interior of the housing to activate the ‘glow in the dark’ material on the interior surface.

20. A container comprising a housing, the housing including ‘glow in the dark’ material on an exterior surface of the housing and at least one member on the housing to provide a dimensional reference for range finding.
